(19) United States
(12) Patent Application Publication
(10) Pub. No.: US 2014/0289198 A1
(43) Pub. Date: Sep. 25, 2014

(54) TRACKING AND MAINTAINING AFFINITY OF MACHINES MIGRATING ACROSS HOSTS OR CLOUDS

(71) Applicant: Ramya Malangi Chikkalingaiah, Bangalore (IN)

(72) Inventor: Ramya Malangi Chikkalingaiah, Bangalore (IN)

(21) Appl. No.: 13/847,096

(22) Filed: Mar. 19, 2013

(51) Int. Cl. G06F 17/30

(52) U.S. Cl. CPC G06F 17/30575
USPC 707/634

(57) ABSTRACT

Affinities between hosts in a virtualized environment may be monitored, such as by analyzing application interactions and network communications. Hosts that are determined to have dependencies on each other may be migrated together to improve performance of the hosts, such as by reducing network traffic. A method for migrating hosts may include determining an affinity between a plurality of hosts on a plurality of servers, identifying a host from the plurality of hosts for migration from a first server of the plurality of servers to a second server of the plurality of servers, and migrating the host from the first server to the second server. The servers may be part of different interconnected clouds.

### FIELD OF THE DISCLOSURE

The instant disclosure relates to computer networks. More specifically, this disclosure relates to executing virtual hosts in computer networks.

### BACKGROUND

Several hosts may be virtualized and executed on a single server. By virtualizing hosts, resources on a single server may be better utilized by sharing the hardware resources. FIG. 1 is a block diagram illustrating a virtualized environment 100 having virtualized hosts across several clouds. A cloud 102 may host servers 102a-c. Each of the servers 102a-c may execute a number of virtual hosts 112a-n. When the hosts 112a-n execute on the server 102c, they share the hardware resources of the server 102c. For example, when one of the hosts is not using the processor, another one of the hosts may be using the processor. Thus, each of the hosts can pay a metered rate for processor time, rather than rent an entire server. Several clouds may be interconnected and cooperate to provide resources to the hosts 112a-n. The cloud 104 may include servers 104a-c. The hosts 112a-n may be transferred between servers 102a-c within the cloud 102 and/or between servers 104a-c within the cloud 104.

Host migration refers to the mobility of hosts within the virtual environment in response to events or conditions. Host migration may occur when a host is instructed to move from one location to another in a scheduled fashion, when a host is instructed to replicate in another location in a scheduled fashion, when a host is instructed to move from one location to another in an unscheduled fashion, when a host is instructed to replicate in another location in an unscheduled fashion, and/or when a host is instructed to move from one cloud to another within the same location.

Host migration may also be carried out according to policies set by an administrator. For example, the server administrator may define a set of rules that provide both the ability to adapt to changing workloads and to respond to and recover from catastrophic events in virtual and physical environments. Host migration capability may improve performance, improve manageability, and improve fault tolerance. Further, host migration may allow workload movement within a short service downtime.

However, a problem with host migration is a lack of tracking the hosts that are moved across the cloud. In particular, network addresses may be reconfigured when the host is transferred. Thus, migration fails to recognize affinity between hosts, such as when hosts interact with each other for application or process sharing. In a cloud, if a host is migrated from one server to another server or from one cloud to another cloud, and the host has a dependency on an application, a service, or management from another host, the migrated host may stop functioning correctly.

### SUMMARY

An exemplary host migration process may include determining an affinity of hosts in different servers and different clouds across a network and using the known affinities to optimize placement of hosts within the network.

According to one embodiment, a method includes determining an affinity between a plurality of hosts on a plurality of servers. The method also includes identifying a host from the plurality of hosts for migration from a first server of the plurality of servers to a second server of the plurality of servers. The method further includes migrating the host from the first server to the second server.

According to another embodiment, a computer program product includes a non-transitory computer readable medium having code to determine an affinity between a plurality of hosts on a plurality of servers. The medium also includes code to identify a host from the plurality of hosts for migration from a first server of the plurality of servers to a second server of the plurality of servers. The medium further includes code to migrate the host from the first server to the second server.

According to yet another embodiment, an apparatus includes a memory and a processor coupled to the memory. The processor is configured to determine an affinity between a plurality of hosts on a plurality of servers. The processor is also configured to identify a host from the plurality of hosts for migration from a first server of the plurality of servers to a second server of the plurality of servers. The processor is further configured to migrate the host from the first server to the second server.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating virtualized hosts across several clouds.

FIG. 2 is a flow chart illustrating an exemplary method for migrating hosts in a virtualized environment according to one embodiment of the disclosure.

FIG. 3 is a block diagram illustrating a switch configuration for hosts according to one embodiment of the disclosure.

FIG. 4 is a block diagram illustrating a host discovery configuration according to one embodiment of the disclosure.

FIG. 5 is a block diagram illustrating a computer network according to one embodiment of the disclosure.

FIG. 6 is a block diagram illustrating a computer system according to one embodiment of the disclosure.

FIG. 7A is a block diagram illustrating a server hosting an emulated software environment for virtualization according to one embodiment of the disclosure.

FIG. 7B is a block diagram illustrating a server hosting an emulated hardware environment according to one embodiment of the disclosure.

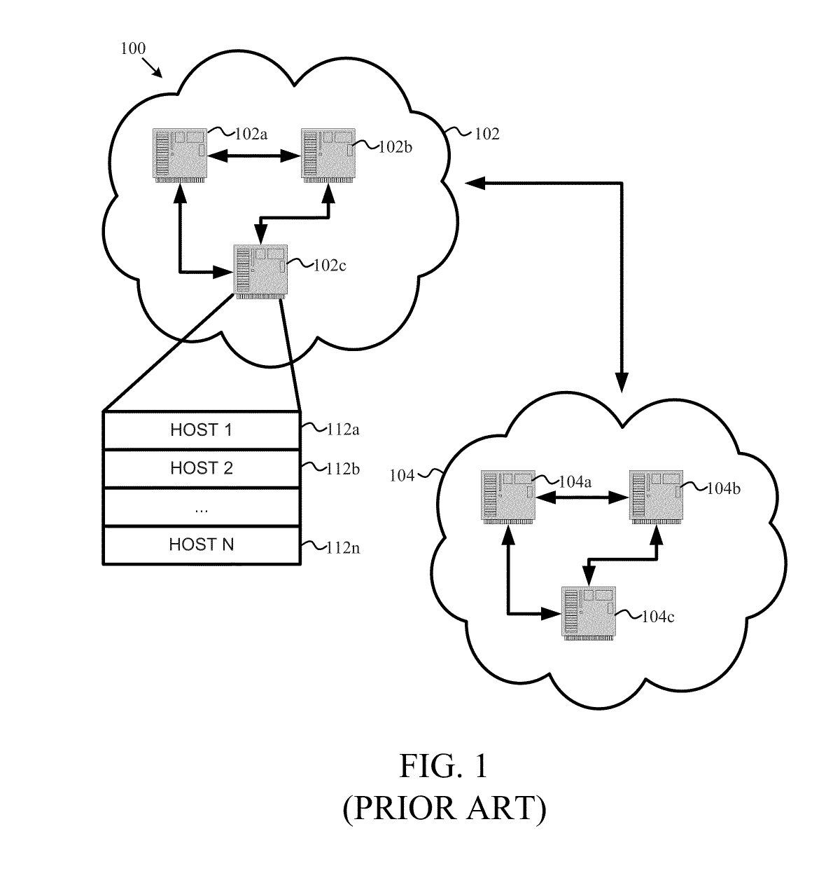

### DETAILED DESCRIPTION

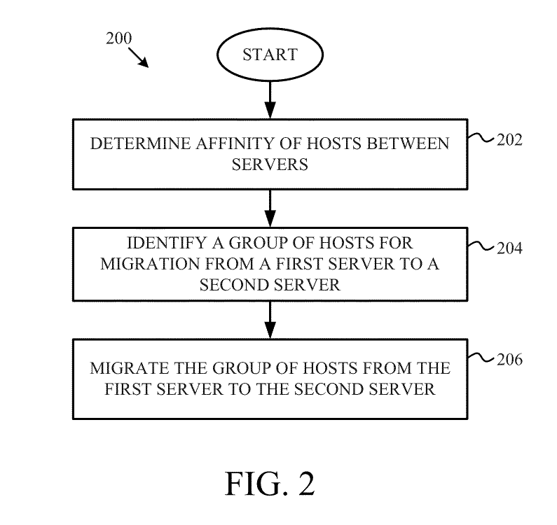

FIG. 2 is a flow chart illustrating an exemplary method for migrating hosts in a virtualized environment according to one embodiment of the disclosure. A method 200 begins at block 202 with determining an affinity between hosts located on different servers, and even within different clouds.

Affinities may be determined at block 202 by examining application interactions between hosts. If a host is interacting with another host on an application basis, the affinity may be found by using the application footprint in the processor of the server by analyzing the application log on the server.

Affinity may also be determined at block 202 by examining traffic through a virtual switch coupled to the hosts. A virtual switch may couple a host on a server to a physical switch coupled to a network. For each physical switch, some network ports may be opened. In the open ports, virtual ports may be created and a virtual port assigned to each virtual host. A virtual port may be a logical subdivision of a physical network port. The virtual port may be assigned for each host when the host first sends traffic or assigned on a pre-provisioned basis by an administrator based on an association with a particular type of traffic on a network, such as storage (e.g., FCoE, iSCSI) and/or on an association with a host network adapter or a host storage adapter. Each port may be assigned to a virtual local area network (VLAN). The configured ports may also be coupled to the virtual switch to enable easy management. Virtual switches may be software network switches that provide an initial switching layer for virtual hosts. The virtual switches forward packets from virtual network interface cards (vNICs) in the host to other hosts on the same server or the cloud through uplink adapters.

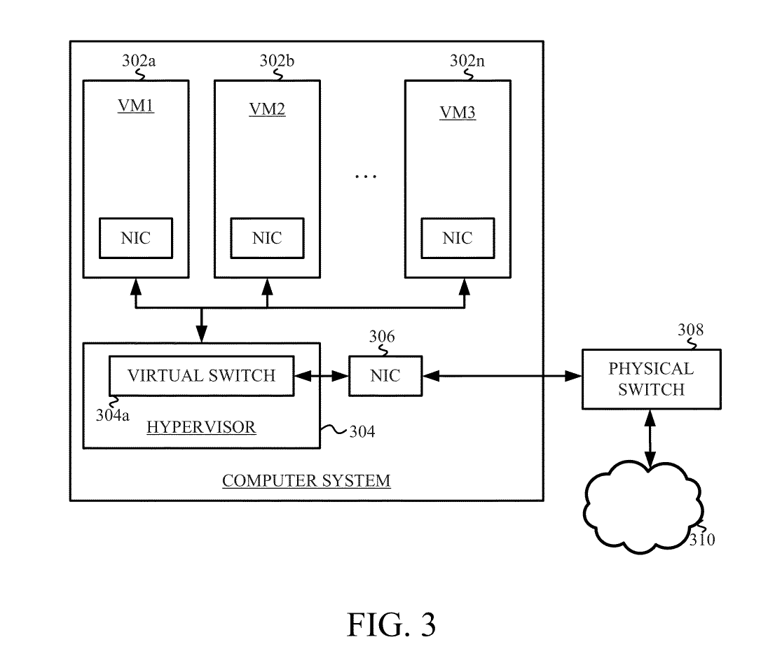

FIG. 3 is a block diagram illustrating a network configuration for virtual machines according to one embodiment of the disclosure. A hypervisor 304 may include software that creates a virtual switch 304a within the hypervisor 304. Each virtual host 302a-n executing within the hypervisor 304 may be provided with a virtual network interface card coupled to the virtual switch 304a. The hypervisor 304 may be executing on a server having a physical network interface card 306. Although not shown, the server may have more than one physical NIC. The physical NIC 306 of the server couples to a physical switch 308 that provides access to a network 310. The virtual switch 304a may provide access to the physical NIC 306 for the virtual hosts 302a-n by traversing packets and examining network addresses within the packets for the appropriate destination.

Because the virtual switch 304a receives all traffic destined for the virtual hosts 302a-n, the virtual switch 304a has access to information regarding how the virtual hosts 302a-n interact with each other and with virtual hosts on other servers (not shown). For example, large quantities of network packets between the virtual host 302a and the virtual host 302b may indicate that there is an affinity between the virtual host 302a and the virtual host 302b.

The virtual switch 304a may be configured as either a single homogeneous switch or a distributed heterogeneous switch. In a homogeneous configuration, two hosts may share a common network, such as VLANs, and a single switch is configured between the two hosts. The switch may assist in migration of hosts by creating a similar configuration with the same IP and hostname in a second server for the migration of hosts. In this arrangement, local host group configurations may be maintained on the switch and do not directly synchronize with hypervisors. Local host groups may include elements such as local switch ports and hosts that are coupled to one of the switch ports or are pre-provisioned on the switch 308. These local host groups may support migration. As hosts move to different hypervisors connected to the switch, the configuration of their group identity and features may be moved with them.

In a heterogeneous configuration, migration may involve adding a virtual port to each of the virtual hosts, after the host starts interacting with another server. According to one embodiment, the network traffic API may be used to identify the port id. Through the port id, information about the host, such as the VLAN, the server IP, and/or the hostname, may be determined. After the hostname is retrieved by using the network monitoring tool, the source and the destination IP address may be updated in a database. When a machine is migrating, an alert may be sent to the administrator regarding the affinity.

Returning to FIG. 2, at block 204 a group of hosts may be identified for migration. For example, the group of hosts may have an affinity, whether application affinity or network affinity. The group of hosts may be identified for migration due to, for example, a hardware failure on a server and/or because an administrator issued a command to migrate. According to one embodiment, a group of hosts may be identified for migration if better performance could be obtained by migrating the hosts to another server. For example, if the group of hosts are spread across multiple servers and cause a high quantity of network traffic between the two servers, the group of hosts may obtain better performance if located on a single server where traffic only passes through a virtual switch rather than a physical switch.

At block 206, the group of hosts may be migrated. Host migration may take place as either a group migration or a migration of an individual virtual host across the cloud. According to one embodiment, migration, whether group or individual, may be completed as a cold migration. That is, all migrating virtual hosts may be shut down, converted to OVF, and migrated. According to another embodiment, migration may be completed as a live migration. That is, the virtual hosts may remain in a power-on state, while a datastore corresponding to the virtual host is migrated to another server. Then, the virtual host may be migrated.

Group migration of a first host and a second host may be performed at block 206 by creating a temporary grouping through a clustering mechanism or by using a virtual appliance. After the grouping is complete, the group may be converted to an Open Virtualization Format (OVF) and saved in a temporary location. Next, if the first and second hosts share a common data store, then the group may be deleted from the first server and the OVF file imported and convert to a configuration format for the second server. If the first and second hosts do not share a common datastore, then the cluster may not be deleted from the first server. The OVF file may be loaded onto the second server after the first and second host are in a power-on state in the second sever. Then, the hosts in the first server may be shutdown, such that there is little or no downtime due to migration of the first and second hosts.

According to one embodiment, if the migration is a live migration, then the hosts may be migrated along with a virtual port and the network configurations for the virtual port to the second server.

According to another embodiment, if the host and the datastore are in two different hypervisors on a server, then the datastore information may be stored in a database and updated when the new hosts are created in the hypervisor on the second server.

Alternatively to group migration, hosts may be individually migrated from a first server to a second server. In one embodiment, the migration is performed manually. First, a media access control (MAC) address may be assigned to the host for transfer. Then, the host application type and MAC address assignment, along with an associated VLAN identifier, may be entered into a network manager.

In another embodiment, the hosts may be transferred automatically by automating the association and migration of a network state to a host's virtual network interface. An application program interface (API) may exist between the hypervisor and the network manager to communicate the machine's tenant type, MAC Addresses, and the VLAN identifier associated with each MAC Address.

When VM migration takes place from a first server in a first cloud to a second server in a second cloud, a new IP address may be allocated to the migrated host. To minimize disruption in network traffic due to the changed IP address, a network redirection scheme may be implemented through IP tunneling and/or with a dynamic domain name service (DNS).

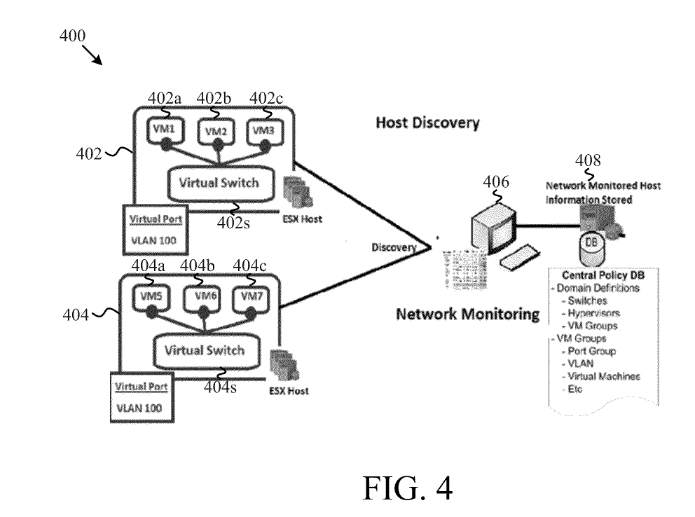

FIG. 4 is a block diagram illustrating a system for host discovery during host migration according to one embodiment of the disclosure. A system 400 may include a first server 402 and a second server 404. The server 402 may execute virtual hosts 402a-c coupled through a virtual switch 402s, and the server 404 may execute virtual hosts 404a-c coupled through a virtual switch 404s. A network monitoring computer 406 may perform discovery, through a connected network, to identify the hosts 402a-c on the server 402 and the hosts 404a-c on the server 404. The network monitoring computer 406 may store information obtained during discovery, such as host name and IP address, in a database hosted on a server 408. The database server 408 may store information for the hosts 420a-c and 404a-c, such as domain definitions, switches, hypervisors, virtual host groups, port groups, and/or VLANs.

The network monitoring computer 406 may first discover hosts within different servers and clouds. After hosts are discovered, the network monitoring computer 406 may monitor the hosts by using a network monitoring tool for network traffic analysis. Analysis may involve fetching the source and destination host details such as hostname, a port identifier, VLAN identifier, MAC address, and/or application information. The machine information fetched may be stored in a network database on the server 408, which is accessible to all the hosts.

An administrator at the network monitoring computer 406 may issue manual commands to migrate virtual hosts between different servers or different clouds. Alternatively, the network monitoring computer 406 may automatically issue commands to migrate virtual hosts based, in part, on affinities determined to exist between the hosts. The alerts, discussed above, may also be presented to an administrator through a user interface on the network monitoring computer 406.

The migration scheme for hosts described above recognizes individual virtual hosts within physical servers, supports any hypervisor type, assigns a unique operating, security and quality of service characteristics for each host, fully integrates with a hypervisor manager to enforce a networking policy in both physical switches and virtual switches, recognizes when virtual hosts are created and migrated, moves network policies in real time to new locations to ensure that virtual hosts remain available and secure as they migrate, and/or tracks virtual hosts in real-time as they migrate and automatically moves the virtual port along with its network configurations to the new physical location.

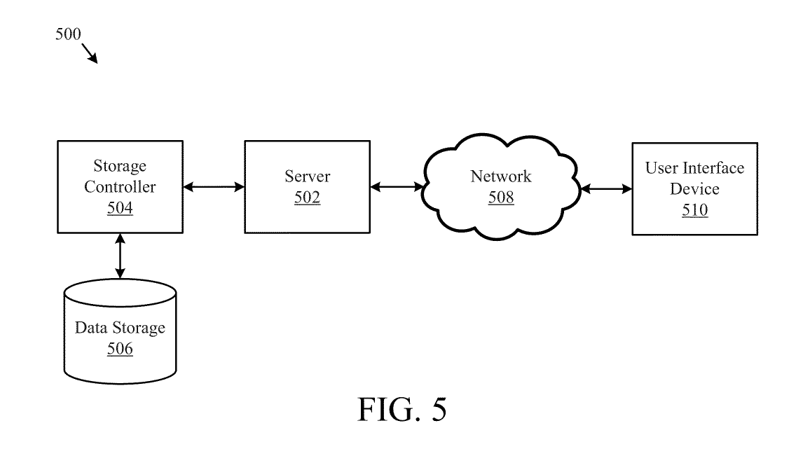

FIG. 5 illustrates one embodiment of a system 500 for an information system, including a system for executing and/or monitoring virtual hosts. The system 500 may include a server 502, a data storage device 506, a network 508, and a user interface device 510. The server 502 may also be a hypervisor-based system executing one or more guest partitions hosting operating systems with modules having server configuration information. In a further embodiment, the system 500 may include a storage controller 504, or a storage server configured to manage data communications between the data storage device 506 and the server 502 or other components in communication with the network 508. In an alternative embodiment, the storage controller 504 may be coupled to the network 508.

In one embodiment, the user interface device 510 is referred to broadly and is intended to encompass a suitable processor-based device such as a desktop computer, a laptop computer, a personal digital assistant (PDA) or tablet computer, a smartphone or other a mobile communication device having access to the network 508. When the device 510 is a mobile device, sensors (not shown), such as a camera or accelerometer, may be embedded in the device 510. When the device 510 is a desktop computer the sensors may be embedded in an attachment (not shown) to the device 510. In a further embodiment, the user interface device 510 may access the Internet or other wide area or local area network to access a web application or web service hosted by the server 502 and may provide a user interface for enabling a user to enter or receive information, such as the status of virtual hosts.

The network 508 may facilitate communications of data between the server 502 and the user interface device 510. The network 508 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

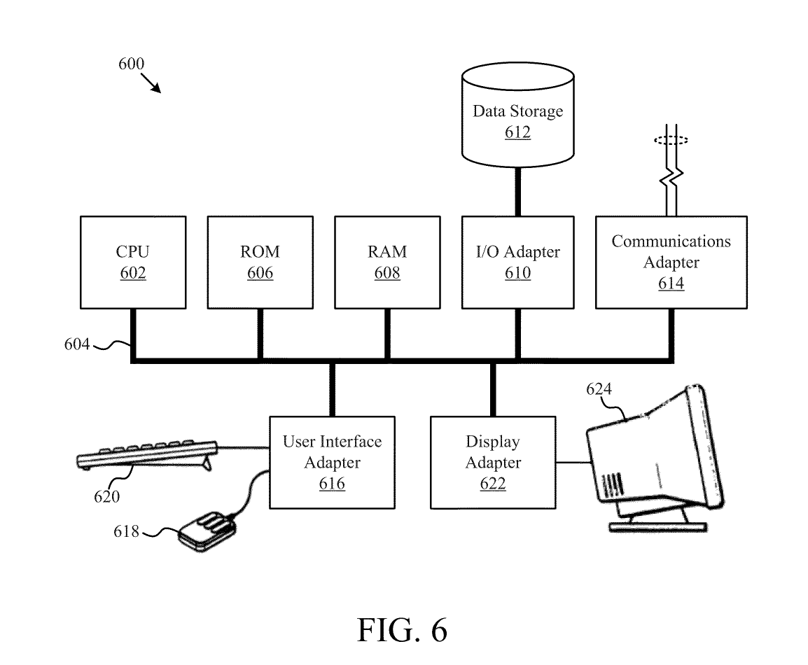

FIG. 6 illustrates a computer system 600 adapted according to certain embodiments of the server 502 and/or the user interface device 510. The central processing unit (“CPU”) 602 is coupled to the system bus 604. The CPU 602 may be a general purpose CPU or microprocessor, graphics processing unit (“GPU”), and/or microcontroller. The present embodiments are not restricted by the architecture of the CPU 602 so long as the CPU 602, whether directly or indirectly, supports the operations as described herein. The CPU 602 may execute the various logical instructions according to the present embodiments.

The computer system 600 also may include random access memory (RAM) 608, which may be synchronous RAM (SRAM), dynamic RAM (DRAM), synchronous dynamic RAM (SDRAM), or the like. The computer system 600 may utilize RAM 608 to store the various data structures used by a software application. The computer system 600 may also include read only memory (ROM) 606 which may be PROM, EPROM, EEPROM, optical storage, or the like. The ROM may store configuration information for booting the computer system 600. The RAM 608 and the ROM 606 hold user and system data, and both the RAM 608 and the ROM 606 may be randomly accessed.

The computer system 600 may also include an input/output (I/O) adapter 610, a communications adapter 614, a user interface adapter 616, and a display adapter 622. The I/O adapter 610 and/or the user interface adapter 616 may, in certain embodiments, enable a user to interact with the computer system 600. In a further embodiment, the display adapter 622 may display a graphical user interface (GUI) associated with a software or web-based application on a display device 624, such as a monitor or touch screen.

The I/O adapter 610 may couple one or more storage devices 612, such as one or more of a hard drive, a solid state storage device, a flash drive, a compact disc (CD) drive, a floppy disk drive, and a tape drive, to the computer system 600. According to one embodiment, the data storage 612 may be a separate server coupled to the computer system 600 through a network connection to the I/O adapter 610. The communications adapter 614 may be adapted to couple the computer system 600 to the network 508, which may be one or more of a LAN, WAN, and/or the Internet. The communications adapter 614 may also be adapted to couple the computer system 600 to other networks such as a global positioning system (GPS) or a Bluetooth network. The user interface adapter 616 couples user input devices, such as a keyboard 620, a pointing device 618, and/or a touch screen (not shown) to the computer system 600. The keyboard 620 may be an on-screen keyboard displayed on a touch panel. Additional devices (not shown) such as a camera, microphone, video camera, accelerometer, compass, and or gyroscope may be coupled to the user interface adapter 616. The display adapter 622 may be driven by the CPU 602 to control the display on the display device 624. Any of the devices 602-622 may be physical and/or logical.

The applications of the present disclosure are not limited to the architecture of computer system 600. Rather the computer system 600 is provided as an example of one type of computing device that may be adapted to perform the functions of the server 502 and/or the user interface device 510. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 600 may be virtualized for access by multiple users and/or applications.

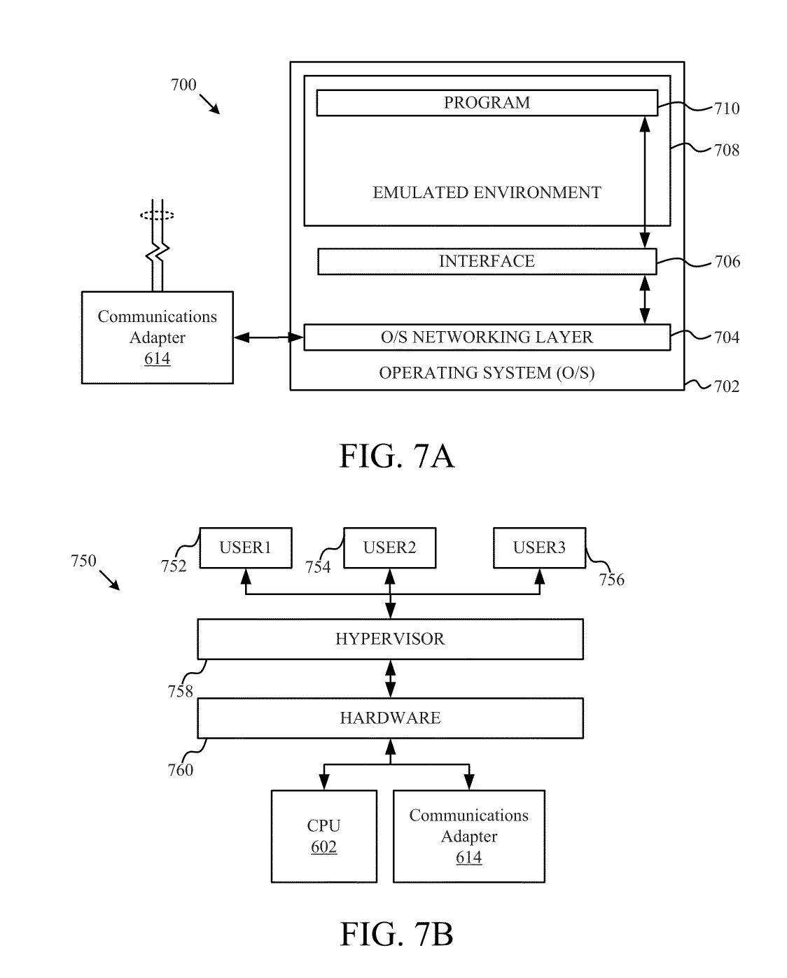

FIG. 7A is a block diagram illustrating a server hosting an emulated software environment for virtualization according to one embodiment of the disclosure. An operating system 702 executing on a server includes drivers for accessing hardware components, such as a networking layer 704 for accessing the communications adapter 714. The operating system 702 may be, for example, Linux. An emulated environment 708 in the operating system 702 executes a program 710, such as CPCommOS. The program 710 accesses the networking layer 704 of the operating system 702 through a non-emulated interface 706, such as XNIOP. The non-emulated interface 706 translates requests from the program 710 executing in the emulated environment 708 for the networking layer 704 of the operating system 702.

In another example, hardware in a computer system may be virtualized through a hypervisor. FIG. 7B is a block diagram illustrating a server hosing an emulated hardware environment according to one embodiment of the disclosure. Users 752, 754, 756 may access the hardware 760 through a hypervisor 758. The hypervisor 758 may be integrated with the hardware 760 to provide virtualization of the hardware 760 without an operating system, such as in the configuration illustrated in FIG. 7A. The hypervisor 758 may provide access to the hardware 760, including the CPU 702 and the communications adaptor 614.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
determining an affinity between a plurality of hosts on a plurality of servers;
identifying a host from the plurality of hosts for migration from a first server of the plurality of servers to a second server of the plurality of servers; and
migrating the host from the first server to the second server.

2. The method of claim 1, in which the first server is part of a first cloud and the second server is part of a second cloud.

3. The method of claim 1, in which migrating the host comprises shutting down the host.

4. The method of claim 1, in which migrating the host comprises:
copying a datastore for the first host from the first server to the second server; and
recreating the first host on the second server.

5. The method of claim 1, in which determining an affinity comprises determining a first host of the plurality of hosts is dependent on a second host of the plurality of hosts through application logs.

6. The method of claim 1, in which determining an affinity comprises determining a first host of the plurality of hosts communicates with a second host of the plurality of hosts.

7. The method of claim 6, in which determining the first host and the second host communicate comprises monitoring a virtual switch within the first server.

8. A computer program product, comprising:
a non-transitory computer readable medium comprising
code to determine an affinity between a plurality of hosts on a plurality of servers;
code to identify a host from the plurality of hosts for migration from a first server of the plurality of servers to a second server of the plurality of servers; and
code to migrate the host from the first server to the second server.

9. The computer program of claim 7, in which the first server is part of a first cloud and the second server is part of a second cloud.

10. The computer program of claim 7, in which the medium further comprises code to shut down the host.

11. The computer program of claim 7, in which the medium further comprises:
code to copy a datastore for the first host from the first server to the second server; and
code to recreate the first host on the second server.

12. The computer program of claim 7, in which the medium further comprises code to determine a first host of the plurality of hosts is dependent on a second host of the plurality of hosts through application logs.

13. The computer program of claim 7, in which the medium further comprises code to determine a first host of the plurality of hosts communicates with a second host of the plurality of hosts.

14. The computer program of claim 13, in which the medium further comprises code to monitor a virtual switch within the first server.

15. An apparatus, comprising:
a memory; and
a processor coupled to the memory, in which the processor is configured:
to determine an affinity between a plurality of hosts on a plurality of servers;
to identify a host from the plurality of hosts for migration from a first server of the plurality of servers to a second server of the plurality of servers; and
to migrate the host from the first server to the second server.

16. The apparatus of claim 15, in which the first server is part of a first cloud and the second server is part of a second cloud.

17. The apparatus of claim 15, in which the processor is further configured to shut down the host.

18. The apparatus of claim 15, in which the processor is further configured to determine a first host of the plurality of hosts is dependent on a second host of the plurality of hosts through application logs.

19. The apparatus of claim 15, in which the processor is further configured to determine a first host of the plurality of hosts communicates with a second host of the plurality of hosts.

20. The apparatus of claim 19, in which the processor is further configured to monitor a virtual switch within the first server.
